(19) United States
(12) Patent Application Publication
(10) Pub. No.: US 2004/0059914 A1
(43) Pub. Date: Mar. 25, 2004

(54) Using signal-generated location information to identify and authenticate available devices

(75) Inventor: Jeyhan Karaoguz, Irvine, CA (US)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Broadcom Corporation

(21) Appl. No.: 10/314,279

(22) Filed: Dec. 9, 2002

Related U.S. Application Data
(60) Provisional application No. 60/409,955, filed on Sep. 12, 2002.

(51) Int. Cl. H04L 9/00

(52) U.S. Cl. 713/168; 380/270

(57) ABSTRACT

An authentication device for authenticating a user of a wireless device within a wireless network can include a receiver configured to receive a request message from a sender to access a resource provided through a wireless network, and a fist processing unit configured to determined first signal-generated location information of the sender. The authentication device can also include a second processing unit configured to identity the sender using the first signal-generated location information, and to conform an identity of the sender, and a transmitter configured to transmit an authentication message authorizing access for the sender to access the resource.

### CROSS REFERENCE TO RELATED APPLICATIONS

This application claims priority of U.S. Provisional Patent Application Ser. No. 60/409,955, entitled Using Signal-Generated Location Information to Identify and Authenticate Available Devices, filed Sep. 12, 2002. The contents of the provisional application are hereby incorporated by reference.

### BACKGROUND OF THE INVENTION

1. Field of the Invention

The present invention relates to a method of and an apparatus for using signal-generated location information to identify and authenticate available devices in a wireless communication network environment such as IEEE 802.11, BLUETOOTH™, Ultra-Wideband (UWB) or any other wireless environment. In particular, the present invention relates to a method of and a system of authenticating and confirming an identity of a user based on the distance range location information and/or the geographic position location information of the user's wireless device. The present invention can be implemented in a wireless network device, which may include discrete devices or which may be implemented on a semiconductor substrate such as a silicon chip.

2.

Currently, cables and wires are predominately used as the communication medium for transferring information such as voice, video, data, etc. from one source to another. For example, cable or wires are commonly used to set up networking infrastructures in business offices, and are also used for personal home computing, and for connecting to the Internet. Generally in a wired network, authentication of a user for accessing the wired network such as a LAN can require the user to sign-on by providing information such as a login ID and a password. And because each work station within the wired network is physically connected to the network and can have a unique address, a communication session between a resource on the wired network and the workstation is generally secure.

On the other hand, as wireless technology continues to advance and grow, and as wireless services become increasingly convenient, the usage and the popularity of wireless devices will also increase especially in public areas. In contrast to wired devices, wireless devices can establish a communication session with a resource without being physically connected to cables or wires. Accordingly, information such as voice, video, and data are transmitted wirelessly from one device to another and the information to can be intercepted or tampered with by impersonators posing as an intended recipient. Therefore, one way to ensure security within a wireless network is to authenticate and identify the intended recipient by using signal-generated location information of the intended recipient.

### SUMMARY OF THE INVENTION

One example of the present invention can be a method of authenticating a user of a wireless device within a wireless network. The method can include the steps of receiving a request message from a sender to access a resource provided through a wireless network, determining first signal-generated location information of the sender, and identifying the sender using the first signal-generated location information. Furthermore, the method can include confirming an identity of the sender, and authorizing access for the sender to access the resource.

In another example, the present invention can relate to an authentication device for authenticating a user of a wireless device within a wireless network. The authenticating device can have a receiver configured to receive a request message from a sender to access a resource provided through a wireless network, a first processing unit configured to determine first signal-generated location information of the sender, and a second processing unit configured to identity the sender using the first signal-generated location information, and to confirm an identity of the sender. In addition, the authenticating device can have a transmitter configured to transmit an authentication message authorizing access for the sender to access the resource.

Additionally, another example of the present invention can provide a system of authenticating a user of a wireless device within a wireless network. The system can include a first receiving means for receiving a request message from a sender to access a resource provided through a wireless network, a first determining means for determining first signal-generated location information of the sender, and an identification means for identifying the sender using the first signal-generated location information. Moreover, the system can have a confirming means for confirming an identity of the sender, and an authorizing means for authorizing access for the sender to access the resource.

### BRIEF DESCRIPTION OF THE DRAWINGS

For proper understanding of the invention, reference should be made to the accompanying drawings, wherein:

FIG. 1 illustrates one example of a wireless network configuration;

FIG. 2 illustrates another example of a wireless network configuration;

FIG. 3 illustrates a flow chart illustrating one example of a method of using signal-generated location information to authenticate and identify available devices, in accordance with the present invention;

FIG. 4 illustrates another flow chart illustrating another example of a method of using signal-generated location information to authenticate and identify available devices, in accordance with the present invention;

FIG. 5 illustrates one example of a hardware configuration for authenticating and identifying available devices based on signal-generated location information, in accordance with the present invention.

### DETAILED DESCRIPTION OF THE PREFERRED EMBODIMENTS

FIG. 1 illustrates one example of a wireless network. The wireless network of FIG. 1 can be an ad hoc network 100 having two or more wireless nodes, stations or devices 101a, 101b, 101c, . . . 101n therein (hereinafter, any reference to device(s) shall also include node(s) and/or station(s)). The ad hoc network 100 can be formed on a temporary basis whereby two or more wireless devices can recognize each other and can establish communications with each other. The wireless devices can be any wireless communication device configured to communicate with the Internet and having multimedia capabilities. For example, devices 101a, 101b, 101c, . . . 101n can be a smart phone, PDA, a mobile laptop computer, a web-pad, a digital video camera, an automobile equipped with a wireless communication device, or any mobile electronic device. Within the ad hoc wireless network 100, each device can communicate with each other on a peer-to-peer level.

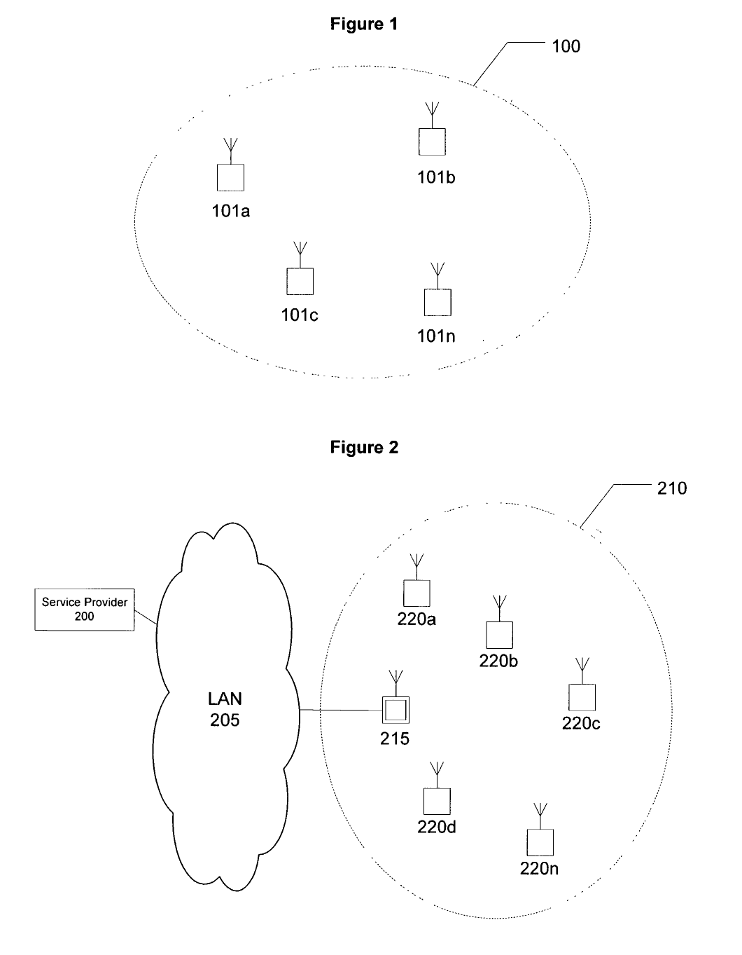

Another example of a wireless network is shown in FIG. 2. FIG. 2 provides a wireless infrastructure network 210 containing an Access Point 215 connected with a LAN 205, such as an Ethernet LAN. In addition, the wireless infrastructure network 210 can contain devices 220a, 220b, 220c, 220d, . . . 220n. The Access Point 215 is connected to the LAN 205 by wires or cables and can be formed as part of the wired network infrastructure 205, having at least one service provider 200. The service provider 200 can include one or more server(s) connected to the LAN 205. One function of the Access Point 215 can be a bridge or a connection between the wireless network 210 and the wired network 205. Accordingly, all communications between the devices 220a, 220b, 220c, 220d, . . . 220n or between the devices and the wired network 205 can go through Access Point 215.

The examples of wireless networks as illustrated in FIGS. 1 and 2 can use wireless technologies such as IEEE 802.11, BLUETOOTH™, UWB, etc.

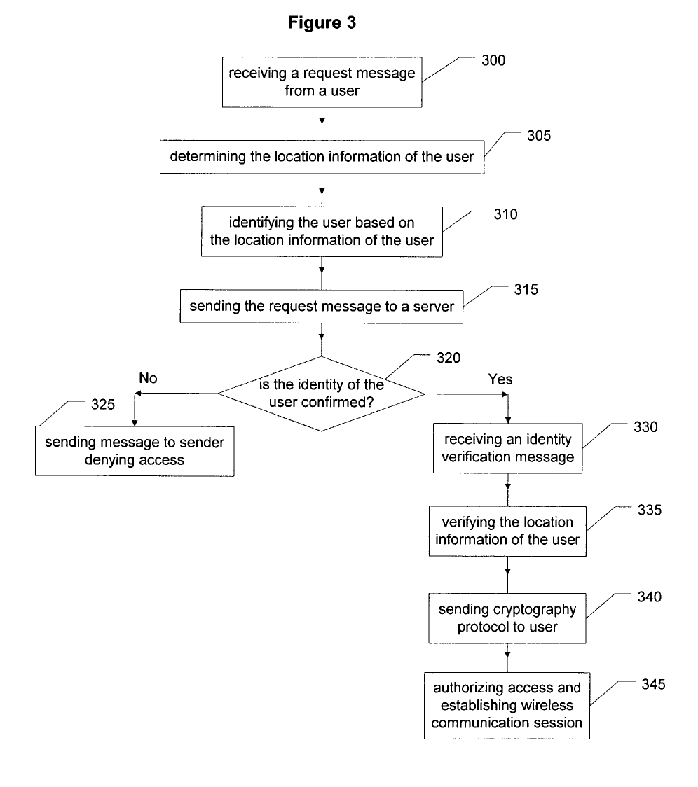

FIG. 3 illustrates one example of a method of authenticating and identifying available devices using their respective location information in accordance with the present invention. Specifically, FIG. 3 illustrates one example of a method of using location information, such as distance range location information and/or geographic position location information to authenticate and identify the wireless device of an intended customer. The method of the present example can be implemented in hardware, or software, or a combination of both hardware and software.

As mentioned above, as wireless technology continues to advance and grow, the usage and the popularity of wireless devices will also increase. Similarly, as wireless service providers offer more and convenient ways to access resources such as the Internet, the number of wireless network customers or users will increase. In order for the wireless network service provider to ensure that only the intended customers, users, and/or recipients have access to the services and resources available to them, the wireless network service provider can use their location information as an extra layer of security to authenticate and identify the intended customer, user or recipient (hereinafter, any reference to customer(s) shall also include user(s) and/or recipient(s)). Therefore, FIG. 3 illustrates one example of using signal-generated location information of an intended customer to authenticate and identify its identity.

A customer having a wireless device can enter a geographic area having a wireless network and having wireless service coverage provide therein. The wireless network can be configured similar to the wireless network as shown in FIG. 2. The wireless network can contain an authentication device, which acts as an access point for the wireless network. The authentication device can be connected to a wired LAN having a server. The wired LAN can be an Ethernet LAN wherein the Ethernet LAN includes one or more service provider(s). The customer enters the wireless network coverage area and can send a request message from the wireless device to the authentication device. The request message can be a request to access resources or services provided by or through the wireless network service provider in which the customer hold a service account. The request message can include information such as the customer's user ID, a password, cryptography protocol, etc. The authentication device can receive the request message from the suer at step 300 of FIG. 3.

After the authentication device receives the request message, the authentication device initiates a signal-generating location information feature within the authentication device to determine the location information of the customer which sent the request message at step 305. The authentication device can determine the location information such as the distance range location information or the geographic location information of the customer in various ways.

In one example, the authentication device can start by transmitting signals such as UWB signals within a predetermined default distance range at a corresponding power output level to locate the customer's wireless device. The authentication device can transmit UWB signals in unidirectional mode or omni-directional mode. In addition, the authentication device can transmit signals in pulses with short duty cycles.

After the transmission of signals either uni-directionally or omni-directionally, the transmitted signals can come into contact with the customer's wireless device, and thereafter the signals can reflect back to the authentication device where the reflected signals can be received by the receiver within the authentication device.

Thereafter, the authentication device monitor and register the timing of the transmission of the signals as well as the timing of the propagation of the signals. For example the authentication device can monitor and record the time each signal is transmitted. Once the transmitted signals are reflected back and received by the receiver, the authentication device can monitor and record the time each signal is received. Based on this information, the authentication device can measure the total time duration for a signal to travel from the transmitter of the authentication device to the customer's wireless device, and to reflect back and received by the receiver.

Based on this information and other factors, such as propagation delay, obstructions, the direction and angle of the signal transmission, the speed at which the signal travels compared to the speed at which light travels, etc., the authentication device can process the information in a location information processor to determine the distance range of the customer's wireless device.

In another example, the authentication device can start by transmitting a range message signal to the customer's wireless device. The range message signal can be sent out from a transmitter within the authentication device. In addition, the range message signal can be UWB, signals transmitted in short duty cycles at a starting time T, such as T=0. Similar to the example above, the transmission of the range message signal can be unidirectional or omni-directional.

After sending the range message signal to the customer's wireless device, the customer's wireless device can receive the range message signal at a time T1. T1 for example, can be the sum of time T. the time of the processing delay ΔP, and the time of the first propagation delay ΔT₁. Thus, the customer's wireless device can receive the range message signal at time T1, and can be represented as follows:

T1=T+ΔP+ΔT₁

Once the customer's wireless device receives the range message signal, the customer's wireless device can process the received range message signal. The customer's wireless device can determine whether or not to further establish communication with the authentication device, and abort the request. In the alternative, the customer's wireless device can automatically respond and can send a range message acknowledgement signal to the authentication device. The range message acknowledgement signal can contain various information about the available device, such as the customer's user ID, personal password, cryptography protocol, etc. The customer's wireless device can send the range message acknowledgement signal at time T2. T2 for example, can be the sum of time T. the time of the processing delay ΔP, the time of the first propagation delay ΔT₁, and the turn-around time ΔTA. The turn-around time ΔTA can represent the period of time from the time the customer's wireless device receives the range message signal to the time the customer's wireless device transmits the range message acknowledgement signal. Accordingly, time T2 can be represented as the following equation.

T2=TΔPΔT₁+ΔTA

At time T2, a range message acknowledgment signal can be sent from the customer's wireless device to the authentication device. After the range message acknowledgement signal reaches the authentication device, the range message acknowledgement signal can be received by the receiver. Once the range message acknowledgment signal is received, the authentication device can thereby determine a total time T_{Total}. The total time T_{Total} can be the sum of time T2 and the second propagation time delay ΔT₂. Accordingly, the total time T_{Total} can be represented by the following equation.

Tₜₒₜₐₗ=T2+ΔT₂

Based on the total time T_{Total}, the information embedded within the range message acknowledgement signal, and other factors such as device related delays, the authentication device can determine the distance range of the customer's wireless device.

In yet another example, the authentication device can determine the geographic position of the customer's wireless device. The authentication device can start by determining the surrounding environment in relation to itself. This information can be already stored within the authentication device if the authentication device remains relatively stationary, or the authentication device can determine the geographic area surrounding itself through a geographic position unit or other positioning systems such as a Global Positioning Systems

Next, the authentication device of the present example can determine it's own position in relation to the immediate surrounding environment. Again, this information can be already stored within the authentication device if the authentication device remains relatively stationary. For example, the authentication device can access data regarding the interior design or interior layout of the immediate environment instantly from a storage unit. In the alternative, the authentication device can transmit initial detecting pulse signals to detect the interior design or interior layout of the surrounding area.

After determining the immediate surrounding geographic area in relation to its own position, the authentication device can determine the distance range of the customer's wireless devices by way of the examples mentioned above. The steps of determining the distance range can include the steps transmitting signals within the surrounding environment, receiving one or more second signal(s), and measuring the total propagation time, etc.

Once the authentication device has determined the distance range of the customer's wireless device in relation to its own position, the authentication device can thereafter determine the coordinates of the customer's wireless device based on information such as the distance range information, the surrounding geographic environment information, the global geographic positioning information, etc. The coordinates of the customer's wireless device can thereby be used to determine the geographic position of customer's location.

Following the determination of the location information of the customer's wireless device, the authentication device can identify the identity of the customer using the determined location information at step 310 of FIG. 3. The authentication device can send the request message along with the information embedded therein to a server at step 315. The server can store information such as account/billing information, personal information, security information, etc., that can identify or can verify the identity of the customer. In addition, the server can verify if the customer's account is paid to date or is in arrears.

The server can access stored information with respect to the customer and determine whether the customer's identity can be confirmed or verified at step 320. If the customer's identity cannot be confirmed or verified because the customer may be an imposter or unauthorized party who improperly or illegally obtained the customer's wireless device, or the customer is in arrears with his/her account, etc., then the server can send a message to the authentication device denying access to the services or resources provide by or through the wireless network. The authentication device can receive the message from the server and thereafter transmit a message signal such as an access denied message or cannot confirm user message, etc. to the customer.

On the hand, if the customer's identity can be confirmed or verified by the server, then the server can send an identity verification message to the authentication device. The server can also send cryptography protocol information and various other information together with the identity verification message to the authentication device. Upon receiving the identity verification message and the cryptography protocol from the server at step 330, the authentication device can verify the location information of the customer by determining the location information of the customer as discussed above at step 335. Once the location information of the customer is determined and verified, the authentication device can respond to the customer's request message and can send the customer the cryptography protocol such as an encryption key and/or a decryption key at step 340. In sending the cryptography protocol, the authentication device authorizes the customer's request to access the resources provided by or through the wireless network, and thereafter can establish a wireless communication session with the customer at step 345. Once the authentication and verification of the customer is confirmed and a communication session is established, the authentication process can be initiated once the session terminates and a new request message is received.

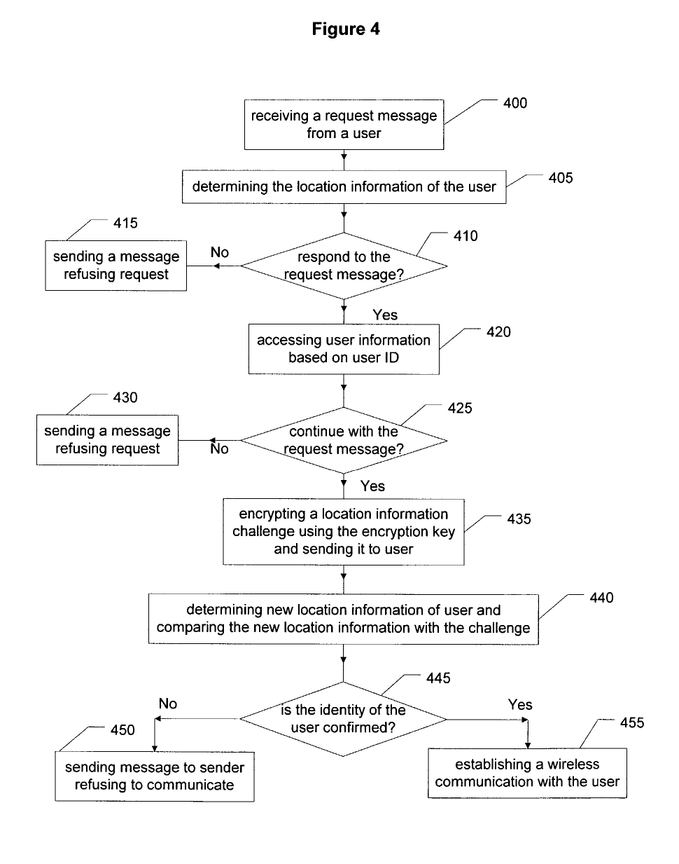

FIG. 4 illustrates another example of a method of authenticating and identifying available devices using their respective location information in accordance with the present invention. Specifically, FIG. 4 illustrates another example of a method of using location information, such as distance range location information and/or geographic position location information to authenticate and identify an intended user of a wireless device in an ad hoc wireless network. The method of the present example can be implemented in hardware or software, or a combination of both hardware and software.

A first user having a wireless device can enter a geographic area having a wireless network. The wireless network can be configured similar to the ad hoc wireless network as shown in FIG. 1. The wireless network can contain a plurality of users with their wireless devices and can be communicating with each other on a peer-to-peer basis.

First user, upon entering the ad hoc wireless network can receive a request message on the first user's wireless device at step 400. The request message can be sent from any other users within the ad hoc wireless network. For purposes of this example, the request message is sent from a second user using a wireless device. The first user's wireless device as well as the second user's wireless device can be integrated with an authentication and identification feature and the wireless devices can operate as an authentication device (hereinafter, any reference to first user and second user can also include reference to the first user's wireless device and the second user's wireless device, respectively).

The request message can be a request to establish communication. Therefore, the request message can include information such as the second user's identification, an encryption key or a public key, data regarding the purpose of the request message, etc. The first user can receive the request message and thereafter can determine the location information, as described above, of the second user that sent the request message at step 405. After determining the location information of the second user, the first user can decide to either respond to the second user's request message or refuse to respond to the request message at step 410. If the first user determines to refuse the second user's request message to communicate, then the first user can send the second user a message refusing the establish communication and decline the second user's request at step 415. It is noted that the first user can use the public key received from the second user to encrypt all messages sent to the second user.

On the other hand, if the first user determines to follow up on the second user's request message, the first user can access and retrieve the second user's previously stored information, if any, from either a storage unit within the first user's wireless device or from another resource separate from the first user's wireless device at step 420. The first user can access and retrieve the second user's information based partly on the user ID embedded within the request message. The retrieved information on the second user can be information regarding the second user's company, contact information, position held at the company, etc., or personal information such as height, weight, age, hobbies, etc.

The first user can review the information retrieved on the second user. And based on the review, the first user can decide to either refuse to continue further with the request message or can follow through with the request message at step 425. If the retrieved information with respect to the second user does appeal to the first user's interest, and/or the first user simply does not want to continue with the request message, then the first user can send the second user a message refusing the establish communication and decline the second user's request at step 430.

If however the first user determines to continue with the request message after reviewing the information regarding the second user, then the first user using the wireless device can encrypt, at step 435, a challenge based on location information using the encryption key or public key sent by the second user. After the encrypting the challenge, the first user using the wireless device can send the location information challenge to the second user also at step 435. The challenge based on location information can be a message to the second user to move to a location specified by the challenge. In other words, the first user can send a challenge requesting the second user to physically relocate his position such as move five meters north from the current position.

Once the challenge is sent to the second user, the first user can receive an acknowledgement message indicating that the challenge has been completed. Thereafter, the first user can determine the new location information of the second user based on steps mentioned above, and can compare the determined new location information of the second user with the location information as set forth in the challenge at step 440.

If the location information challenge is met and the determined new location information of the second user matches the location information as set forth in the challenge, then the second user's identity can be authenticated and confirmed. Thereafter, the first user can accept the request message and can establish a wireless communication session with the second user at step 455. If however, the location information challenge is not met, and/or the determined location information does not match the location information specified in the challenge, then the second user's identity can not be authenticated or confirmed. Therefore, the first user can send a message to the second user refusing to establish communication at step 450. Once the authentication and verification of the second user is confirmed and a communication session is established, the authentication process can be initiated once the session terminates and a new request message is received.

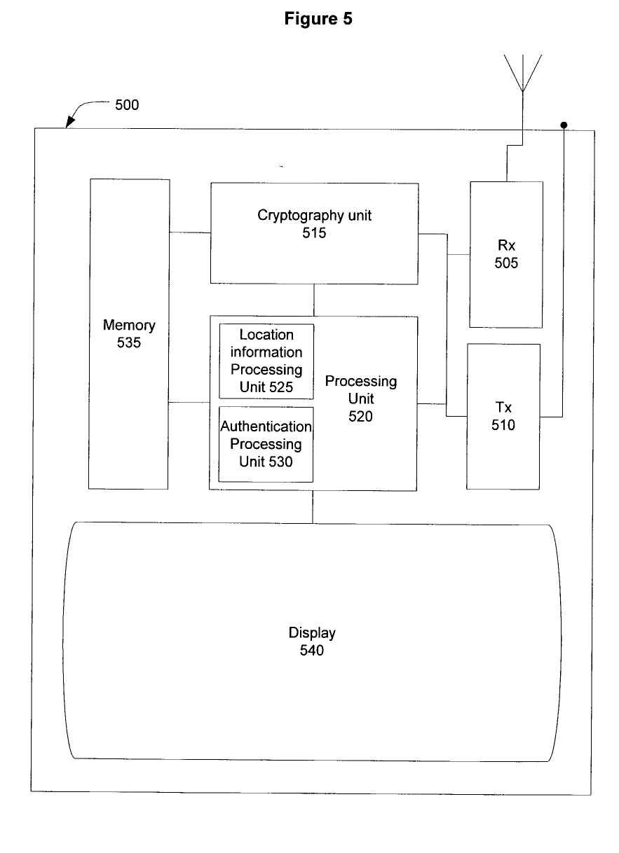

FIG. 5 illustrates one example of a hardware configuration that can use determined location information to authenticate and identify intended customers or users of wireless devices within a wireless network, in accordance with the present invention. In addition, the hardware configuration of FIG. 5 can be in an integrated, modular and single chip solution, and therefore can be embodied on a semiconductor substrate, such as silicon. Alternatively, the hardware configuration of FIG. 5 can be a plurality of discrete components on a circuit board. The configuration can also be implemented as a general purpose device configured to implement the invention with software.

FIG. 5 illustrates an authentication device 500 configured to authenticate and identify an intended user or customer of a wireless device using the location information of the wireless device. The authentication device 500 contains a receiver 505 and a transmitter 510. The transmitter 510 can transmit electro-magnetic signals as well as various other signals including UWB signals. The transmitter 510 can transmit signals in short pulses in short duty cycles. In the alternative, the receiver 505 can receive electro-magnetic signals as well as various other signals including UWB signals.

Furthermore, the authentication device 500 can include a cryptography unit 515 and a memory 535. The cryptography unit 515 can store cryptography protocol information such as a public key and/or private key. Furthermore, the memory 535 can store information such as geographic maps, personal and professional information about particular individuals, or can store default values and look-up table, etc.

FIG. 5 also shows a processing unit 520, and a location information processing unit 525 for determining the location information such as the distance range or geographic location information of the wireless devices. It is noted that the location information processing unit 525 can be a separate processing unit. It is further noted that although the location information processing unit 525 is shown to be within the processing unit 520, the location information processing unit 525 can be a separate and distinct processing unit from the processing unit 520.

Therefore, the processing unit 520 can be the main processing unit and can process functions outside the realms of the location information processing unit 525. The location information processing unit 525 can therefore perform all the functions and tasks related to the determining of the range and geographic position location information of the available wireless devices. For instance, the location information processing unit 525 can measure or calculate the period of time period from the time a first signal is transmitted to the time a second signal is received. Similarly, the location information processing unit 525 can perform all the functions and tasks related to the determining of the geographic position of the available wireless devices. These processing functions can include determining the geographic coordinates of the available wireless devices within the surrounding geographic environment of the authentication device 500.

Furthermore, FIG. 5 includes an authentication processing unit 530 and a display 540. The authentication processing unit 530 can perform tasks and function related to the authentication, confirmation and verification of an intended user or customer, etc. The display 540 can be a plasma display, a LCD display or various other types of display for displaying multimedia information.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

We claim:

1. A method of authenticating a user of a wireless device within a wireless network, said method comprising the steps of:
receiving a request message from a sender to access a resource provided through a wireless network;
determining first signal-generated location information of the sender;
identifying the sender using the first signal-generated location information;
confirming an identity of the sender; and
authorizing access for the sender to access the resource.

2. The method of claim 1, wherein the step of receiving the request message comprises the step of:
receiving a user identification and a user password from the sender to access the resource provided through the wireless network.

3. The method of claim 1, wherein the step of determining the first signal-generated location information comprises the steps of:
transmitting a first signal to the sender;
receiving a second signal from the sender; and
determining a distance range or a geographic position of the sender based on the first signal and the second signal.

4. The method of claim 1, wherein the step of identifying the sender comprises the steps of:
sending the request message to a server; and
receiving an identity verification of the sender from the server when the identity of the sender is confirmed.

5. The method of claim 4, wherein the step of identifying the sender comprises the steps of:
verifying the first signal-generated location information of the sender; and
receiving a cryptography protocol from the server.

6. The method of claim 5, further comprising the step of:
sending the cryptography protocol to the sender.

7. The method of claim 6,wherein the step of sending the cryptography protocol comprises the step of:
sending at least one encryption key and at least one decryption key to the sender.

8. The method of claim 7, wherein the step of authorizing access for the sender comprises the step of:
establishing a wireless communication session with the sender using the at least one encryption key and the at least one decryption key.

9. The method of claim 1, wherein the step of receiving the request message comprises the step of:
receiving a user identification and an encryption key from the sender.

10. The method of claim 9, wherein the step of identifying the sender comprises the steps of:
accessing user information based on the user identification;
encrypting a location information challenge using the encryption key; and
sending the location information challenge to the sender.

11. The method of claim 10, wherein the step of confirming an identity comprises the steps of:
determining second signal-generated location information of the sender; and
comparing the second signal-generated location with the location information challenge.

12. The method of claim 11, wherein the step of authorizing access for the sender comprises the step of:
establishing a wireless communication session with the sender when the second signal-generated location matches the location information challenge.

13. An authentication device for authenticating a user of a wireless device within a wireless network, said authentication device comprising:
a receiver configured to receive a request message from a sender to access a resource provided through a wireless network;
a first processing unit configured to determine first signal-generated location information of the sender;
a second processing unit configured to identity the sender using the first signal-generated location information, and to confirm an identity of the sender;
a transmitter configured to transmit an authentication message authorizing access for the sender to access the resource.

14. The authentication device of claim 13, wherein the receiver is configured to receive a user identification and a user password from the sender to access the resource provided through the wireless network.

15. The authentication device of claim 13, wherein the first processing unit is configured to determine a distance range or a geographic position of the sender.

16. The authentication device of claim 13, wherein the second processing unit is configured to send the request message to a server; and is configured to receive an identity verification of the sender from the server when the identity of the sender is confirmed.

17. The authentication device of claim 16, wherein the second processing unit is configured to verify the first signal-generated location information of the sender, and is configured to receive a cryptography protocol from the server.

18. The authentication device of claim 17, wherein the transmitter is configured to send the cryptography protocol to the sender.

19. The authentication device of claim 18, wherein the transmitter is configured to send at least one encryption key and at least one decryption key to the sender.

20. The authentication device of claim 19, wherein the second processing unit is configured to establish a wireless communication session with the sender using the at least one encryption key and the at least one decryption key.

21. The authentication device of claim 13, wherein the receiver is configured to receive a user identification and an encryption key from the sender.

22. The authentication device of claim 21, further comprising:
a memory configured to store user information.

23. The authentication device of claim 21, wherein the second processing unit is configured to access the user information based on the user identification.

24. The authentication device of claim 23, further comprising:
a cryptography unit configured to encrypt a location information challenge using the encryption key.

25. The authentication device of claim 24, wherein the transmitter is configured to send the location information challenge to the sender.

26. The authentication device of claim 25, wherein the first processing unit is configured to determine second signal-generated location information of the sender, and is configured to compare the second signal-generated location with the location information challenge.

27. The authentication device of claim 26, wherein the second processing unit is configured to establish a wireless communication session with the sender when the second signal-generated location matches the location information challenge.

28. A system of authenticating a user of a wireless device within a wireless network, said system comprises:
a first receiving means for receiving a request message from a sender to access a resource provided through a wireless network;
a first determining means for determining first signal-generated location information of the sender;
an identification means for identifying the sender using the first signal-generated location information;
a conforming means for confirming an identity of the sender; and
an authorizing means for authorizing access for the sender to access the resource.

29. The system of claim 28, wherein the first receiving means receives a user identification and a user password from the sender to access the resource provided through the wireless network.

30. The system of claim 28, wherein the first determining means comprises:
a transmitting means for transmitting a first signal to the sender;
a second receiving means for receiving a second signal from the sender; and
a second determining means for determining a distance range or a geographic position of the sender based on the first signal and the second signal.

31. The system of claim 28, wherein the identifying means comprises:
a sending means for sending the request message to a server; and
a second receiving means for receiving an identity verification of the sender from the server when the identity of the sender is confirmed.

32. The system of claim 31, wherein the identifying means comprises:
a verifying means for verifying the first signal-generated location information of the sender; and
a third receiving means for receiving a cryptography protocol from the server.

33. The system of claim 32, further comprising:
a transmitting means for transmitting the cryptography protocol to the sender.

34. The system of claim 33, wherein the transmitting means transmits at least one encryption key and at least one decryption key to the sender.

35. The system of claim 34, wherein the authorizing means authorizes the sender to establish a wireless communication session using the at least one encryption key and the at least one decryption key.

36. The system of claim 28, wherein the first receiving means receives a user identification and an encryption key from the sender.

37. The system of claim 36, wherein the identifying means comprises:
an accessing means for accessing user information based on the user identification;
an encrypting means for encrypting a location information challenge using the encryption key; and
a transmitting means for transmitting the location information challenge to the sender.

38. The system of claim 37,wherein the confirming means comprises:
a second determining means for determining a second signal-generated location information of the sender; and
a comparing means for comparing the second signal-generated location with the location information challenge.

39. The system of claim 38, wherein the authorizing means authorizes the sender to establish a wireless communication session when the second signal-generated location matches the location information challenge.
